(19) United States
(12) Patent Application Publication
(10) Pub. No.: US 2009/0046326 A1
(43) Pub. Date: Feb. 19, 2009

(54) Image processing device, method of controlling the same, and program

(75) Inventors: Naoki Nakajo, Shiojiri-shi (JP); Tokunori Akahane, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/228,458

(22) Filed: Aug. 13, 2008

(30) Foreign Application Priority Data
Aug. 13, 2007 (JP) 2007-210744

(51) Int. Cl. H04N 1/40

(52) U.S. Cl. 358/448

(57) ABSTRACT

An image processing device includes a display unit, an image reading unit that reads a photo image, an extracting unit that extracts a characteristic amount of a face region of a person included in the photo image,a storing unit that stores the characteristic amount and shaping information that is used for shaping the face region of the person to be associated with each other, and a performing unit that reads out the shaping information from the storing unit, shapes the face region of the person based on the shaping information, and displays the shaped face region of the person in the display unit.

### BACKGROUND

1. Technical Field

The present invention relates to an image processing device, a method of controlling the image processing device, and a program.

2. Related Art

Image processing devices that correct image data have been known. For example, in an image processing device disclosed in JP-A-2005-31990, an image of a pupil area that is automatically specified is enlarged. In addition, under the state, when the image of the pupil area crosses the contour of an eye surrounded by the eyelid of a subject, a portion protruding from the contour of the eye, in the image of the enlarged pupil area, is automatically deleted. Accordingly, the size of the pupil included in a facial image is enlarged naturally, and thus an image giving a viewer a good impression can be generated.

However, in the image processing device disclosed in JP-A-2005-31990, the size of the pupil is enlarged with a same scale for all the persons regardless of a person included in the photo image. Thus, even when the enlarged pupil is appropriate for a specific person, there may be a case where the enlarged pupil is not appropriate for another person.

### SUMMARY

An advantage of some aspects of the invention is that it provides appropriate shaping for each person included in the photo image automatically.

The invention employs the following means.

According to a first aspect of the invention, there is provided an image processing device including: a display unit that displays a character, a figure, a symbol, and the like; an image reading unit that reads a photo image; a characteristic amount extracting unit that extracts a characteristic amount of a face region of a person included in the photo image read by the image reading unit; a shaping information storing unit that stores the characteristic amount and shaping information that is used for shaping a person's face to be associated with each other; and a shaping performing unit that reads out the shaping information that is associated with the characteristic amount extracted by the characteristic amount extracting unit from the shaping information storing unit, shapes the person's face based on the read-out shaping information, and displays the photo image after the shaping process in the display unit.

In the above-described image processing device, the characteristic amount of the face region of each person included in a photo image read by the image reading unit is extracted, shaping information associated with the characteristic amount is read out from the shaping information storing unit, the face of the person is shaped based on the read-out shaping information, and a photo image after the shaping process is displayed in the display unit. In other words, the face of a person displayed in the display is shaped to be displayed based on not shaping information determined uniformly but shaping information associated with the characteristic amount. Accordingly, an appropriate shaping process for each person included in the photo image can be performed automatically. Here, the characteristic amount is an index for representing a plurality of characteristics of a person's face. For example, the characteristic amount may be sizes of eyes and a mouth, or may be a distance between two eyes. In addition, the shaping information is information on a face such as the size of the face, the size of the eyes, or the color of the skin. The shaping information may represent changing the sizes of the face and the eye in the read-out photo image at a predetermined rate (for example, 1%) or represent changing the color of the skin in the read-out photo image at a predetermined rate (for example, 1%).

In the above-described image processing device, it may be configured that the shaping information storing unit stores one type or a plurality of types of the shaping information for each characteristic amount, and the shaping performing unit, in a case where there is a plurality of types of the shaping information that is associated with the characteristic amount extracted by the characteristic amount extracting unit, displays the plurality of the types of the shaping information in the display unit as options, waits for a user to select one of the plurality of the types of the shaping information, shaping the person's face based on the selected type of the shaping information, and displays the photo image after the shaping process in the display unit. In such a case, for example, when there are cases where a gorgeous face is desired to be formed for a specific person and a plain face is desired to be formed for the person, a desired shape of the face can be formed by selecting the type of the shaping information for each case.

In the above-described image processing device, the shaping information storing unit may be configured to store the characteristic amount for a direction of the person's face and the shaping information in association with each other. In such a case, when shaping information associated with the characteristic amount extracted by the characteristic amount extracting unit is read out from the shaping information storing unit, the characteristic amount is a characteristic amount corresponding to the person's face direction. Accordingly, even when the user wants different shaping processes for cases where the face is positioned to face the front side and the side, such a demand can be satisfied. Here, the face direction, for example, may be a left-to-right direction or a left-to-right direction, an upper direction or a lower direction, or a front direction.

In the above-described image processing device, a shaping information inputting unit in which the user inputs the shaping information may be further included. In such a case, the shaping information storing unit may be configured to store the characteristic amount extracted by the characteristic amount extracting unit and the shaping information input by using the shaping information inputting unit in association with each other. In such a case, a user can store desired shaping information in the shaping information storing unit, and accordingly, a shaping process can be automatically performed so as to form the shape of the face close to the user's taste.

In the image processing device, the shaping performing unit may be configured to display the photo image after the shaping process and the photo image before the shaping process in the display unit in a case where the person's face has been shaped. In such a case, a user can check a difference between the face before the shaping process and the face after the shaping process in an easy manner.

According to a second aspect of the invention, there is provided a method of controlling an image processing device having a display unit that displays a character, a figure, a symbol, and the like, an image reading unit that reads a photo image, and a shaping information storing unit that stores a characteristic amount of a face region of a person and shaping information, which is used for shaping the person's face, in association with each other, by using computer software. The method includes: (a) extracting the characteristic amount of a face region of a person included in the photo image read by the image reading unit; and (b) reading out the shaping information associated with the characteristic amount extracted in the (a) from the shaping information storing unit, shaping the person's face based on the read-out shaping information, and displaying the photo image after the shaping process in the display unit.

In the above-described method of controlling the image processing device, the characteristic amount of the face region of each person included in a photo image read by the image reading unit is extracted, shaping information associated with the characteristic amount is read out from the shaping information storing unit, the face of the person is shaped based on the read-out shaping information, and a photo image after the shaping process is displayed in the display unit. In other words, the face of a person displayed in the display is shaped to be displayed based on not shaping information determined uniformly but shaping information associated with the characteristic amount. Accordingly, an appropriate shaping process for each person included in the photo image can be performed automatically. In addition, in the above-described method of controlling the image processing device, a step for implementing the function of any one of the above-described image processing devices may be added.

According to a third aspect of the invention, there is provided a control program for implementing the above-described method of controlling the image processing device in one or a plurality of computers. The program may be recorded in a computer-readable recording medium (for example, a hard disk, a ROM, an FD, a CD, a DVD, or the like), or may be transmitted from a computer to another computer through a transmission media (a communication network such as the Internet or a LAN). In addition, the program may be transmitted and received in any other form. By executing the program in one computer or executing each step of the program in a plurality of computers in a shared manner, the same advantages as those acquired by using the above-described control method can be acquired.

### BRIEF DESCRIPTION OF THE DRAWINGS

The invention will be described with reference to the accompanying drawings, wherein like numbers reference like elements.

FIG. 1 is a perspective view of a photo printer 10 according to an embodiment of the invention.

FIG. 2 is a schematic diagram showing the configuration of the photo printer 10.

FIG. 3 is a flowchart showing an example of an image shaping process routine according to an embodiment of the invention.

FIG. 4 is a diagram showing an example of a shaping information table and a multiplying factor setting table according to an embodiment of the invention.

FIGS. 5A, 5B, and 5C are diagrams showing a display example displayed in a manual shaping process according to an embodiment of the invention, as an example.

FIG. 6 is a diagram showing an example of a saving content checking screen according to an embodiment of the invention.

FIG. 7 is a diagram showing a shaping information table according to another embodiment of the invention.

### DESCRIPTION OF EXEMPLARY EMBODIMENTS

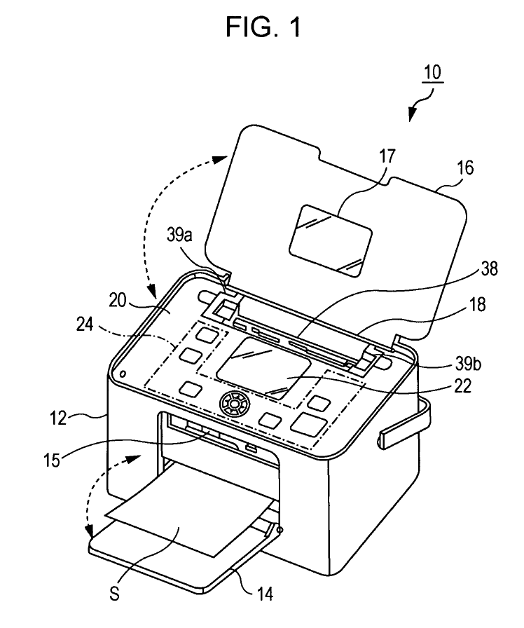

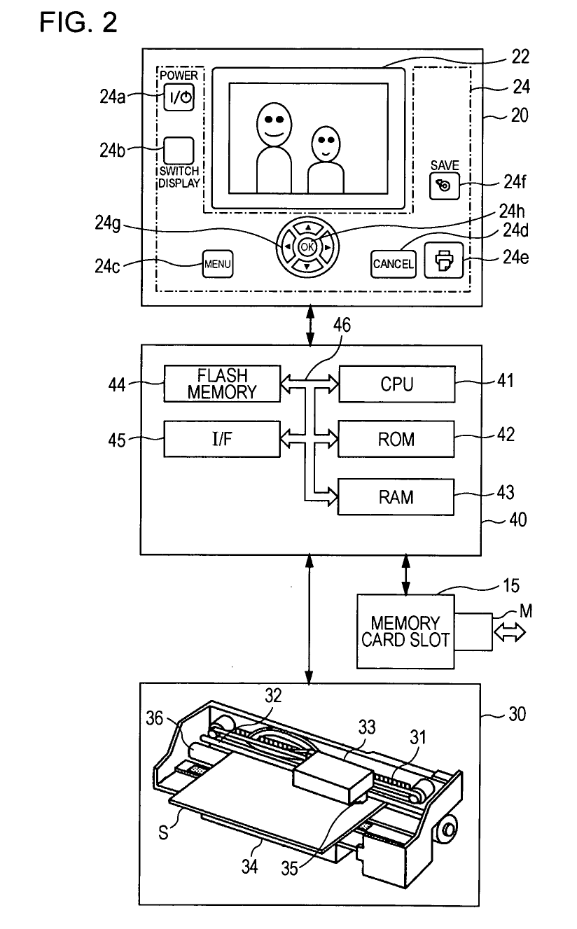

Hereinafter, an embodiment of the present invention will be described with reference to the accompanying drawings. FIG. 1 is a perspective view of a photo printer 10 according to an embodiment of the invention. FIG. 2 is a schematic diagram showing the configuration of the photo printer 10.

The photo printer 10 according to this embodiment, as shown in FIG. 1, includes a front door 14 that can open or close a front face of a printer main body 12, a cover 16 that is installed to an inner side of the top face of the printer main body 12 to be able to be opened or closed and covers an operation panel 20 in a closed state, the operation panel 20 disposed on the top face of the printer main body 12, a printing mechanism 30 (see FIG. 2) that is built in the printer main body 12, and a controller 40 (see FIG. 2) responsible for controlling the overall photo printer 10. In this embodiment, although a printing medium is described as a paper sheet S, the material thereof is not particularly limited. Thus, other materials such as a film other than the paper sheet may be used as the printing medium.

The front door 14 is a cover that is used for opening or closing the front face of the printer main body 12. As shown in FIG. 1, in an open state, the front door 14 serves as a paper discharge tray for receiving a paper sheet S discharged from the front face of the printer main body 12 and allows various types of memory card slots 15 disposed on the front face of the printer main body 12 to be in a state usable by a user.

The cover 16 is a resin plate molded to have a size for covering the top face of the printer main body 12. The cover 16 has a window 17 having a same size as that of a display 22 and is installed to a cover supporting shaft 18 to be able to be opened or closed. In addition, as shown in FIG. 1, when the cover 16 is in an open state, the cover can be used as a paper feed tray that is used for supplying a paper sheet S to the printing mechanism 30.

The operation panel 20 includes the display 22 that is used for displaying a character, a figure, a symbol, and the like and a group of buttons 24 that are disposed in the periphery of the display 22. The group of buttons 24, as shown in FIG. 2, includes a power button 24a that is used for turning the power on or off, a display switching button 24b that is used for switching an image displayed in the display 22, a menu button 24c that is used for calling out a main menu screen in which a plurality of options relating to a print function is aligned, a cancel button 24d that is used for cancelling an operation in the middle or interrupting a print operation for a paper sheet S in the middle, a print button 24e that is used for directing to perform a print operation for the print sheet S, a save button 24f that is used for saving a photo image or the like in a memory card M inserted into the memory card slot 15, up, down, left, and right buttons 24g that are operated in a process for selecting an option from the plurality of options displayed in the display 22 for moving the cursor, an OK button 24h that is disposed in the center of the up, down, left, and right buttons 24g and used for directing a determined content as the option selected by the up, down, left, and right buttons 24g, and the like. In addition, as shown in FIG. 1, inside the operation panel 20, a paper feed opening 38 of the printing mechanism 30 is disposed. In the paper feed opening 38, a pair of paper guides 39a and 39b that are operated to be sled to left and right sides such that the guide width is adjusted to the width of the paper sheet P is disposed.

The printing mechanism 30 is disposed inside the printer main body 12. As shown in FIG. 2, the printing mechanism 30 includes a carriage 33 that is driven by a carriage belt 31 horizontally suspended in a loop shape and reciprocates horizontally along a guide 32, ink cartridges 34 that supply ink of colors such as cyan, magenta, yellow, and black to the carriage 33, a print head 35 that ejects ink toward a print sheet S from nozzles by applying pressure to the ink that is supplied from the ink cartridges 34, and a transport roller 36 that transports the paper sheet S supplied from the paper feed opening 38 (see FIG. 1), which is formed in the operation panel 20, to a front door 14 in an open state serving as the a paper discharge tray. The ink cartridges 34 are installed to a lower part of the printing mechanism 30 and forms so-called an off-carriage type in which the ink cartridges 34 are not built on the carriage 33. Here, the print head 35 employs a method in which ink is pressed by applying a voltage to a piezoelectric element so as to transform the piezoelectric element. However, a method in which ink is pressed by air bubbles generated by applying a voltage to a heating resistor (for example, a heater) so as to heat the ink may be used.

The controller 40, as shown in FIG. 2, is constituted by a microprocessor that has a CPU 41 as its primary element. The controller 40 includes a ROM 42 that stores various process programs (an image shaping process to be described later and the like), various types of data, and the like, a RAM 43 that temporarily stores data, a flash memory 44 that stores shaping information and the like, is electrically rewritable, and maintains data in a power-off state, and an interface 45 (hereinafter, referred to as an I/F 45) through which communication with the memory card M inserted into the memory card slot 15 or the printing mechanism 30 can be made. These constituent elements are interconnected together through a bus 46 for exchanging signals thereof. The controller 40 inputs a photo image or the like that is stored in the memory card M inserted into the memory card slot 15 and receives a detection signal or the like from the group of buttons 24 and each part of the printing mechanism 30. In addition, the controller 40 saves a shaped photo image or the like into the memory card M, and outputs a control signal or the like to each part of the printing mechanism 30.

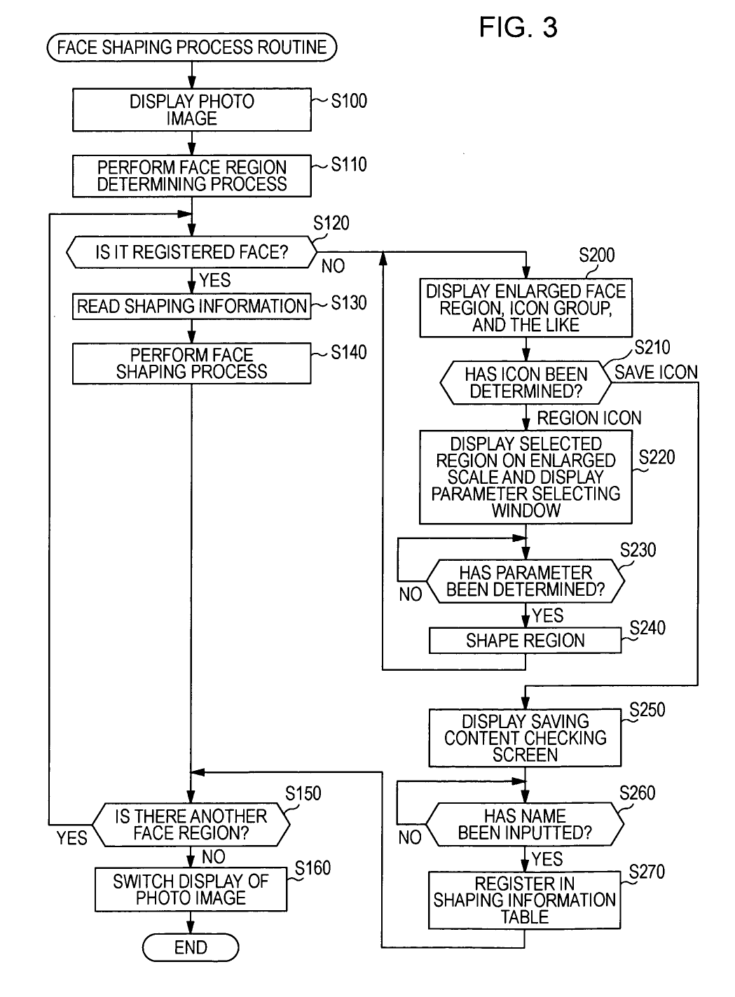

Next, the operation of the above-described photo printer 10 according to this embodiment, and more particularly, the operation for an image shaping process will be described. FIG. 3 is a flowchart showing an example of an image shaping process routine that is performed by the CPU 41 of the photo printer 10. This routine is stored in the ROM 42 and repeatedly performed by the CPU 41 in a case where a photo image including an image of a person is read out from the memory card M.

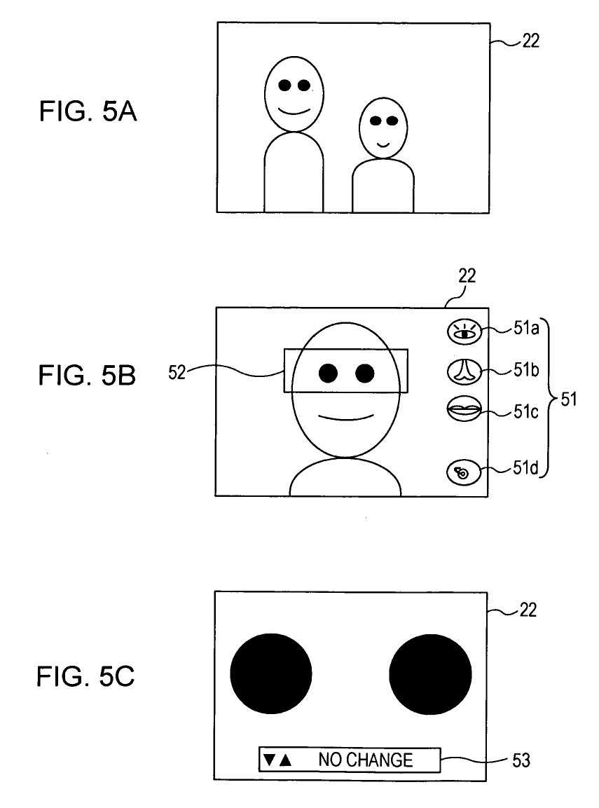

When the image shaping process routine shown in FIG. 3 is started, the CPU 41 displays the read photo image in the display 22 (Step S100, see FIG. 5A) and performs a face region determining process for the read photo image (Step S110) so as to determine a face region included in the photo image. Here, since the method of determining a face region is known technology, a detailed description of the face region determining process is omitted here. For example, a method in which pixels having a color close to a color designated as a skin color in the photo image are extracted as a set of skin-color pixels may be used. This method is performed, for example, in a color space for differentiating a skin color from other colors, by determining a predetermined range of the skin color in the color space and determining whether the color of each pixel is within the determined rage. In such a case, it may be configured that average luminance of a color image is calculated by converting image data into a color space of hue, chroma, and luminance, an appropriate range of skin-color pixel values for each predetermined range of the calculated average luminance is set in advance, and areas having skin-color pixel values within the ranges are extracted as a set of skin-color pixels. As described above, when an average of luminance of an image is divided into a plurality of ranges and the range of skin-color pixel values is set for each region, an appropriate range of the skin-color pixels can be set based on whether the whole image is bright or dark. As a result, detection of skin-color pixels can be performed more precisely. Accordingly, a set of the skin-color pixels can be extracted. In such a case, only an image area in which skin-color pixels of a predetermined number (for example, 10 pixels or larger than 1% of the total number of pixels of the entire image) or more are aggregated in a contact state may be extracted. After the set of the skin-color pixels is extracted, the CPU 41 extracts an eye and a mouth from the set of the skin-color pixels. Here, since a method of extracting the positions of the eye and mouth is known technology, a detailed description thereof is omitted here. For example, an area having a relatively low luminance value in the area corresponding to the set of the skin-color pixels is extracted as an eye area from the area corresponding to the set of the skin-color pixels. In addition, in the range located on the lower side of the extracted two eyes, an area having a relatively low luminance value in the area corresponding to the set of the skin-color pixels is extracted as a mouth region from the area corresponding to the set of the skin-color pixels. In such a case, the extraction operation may be performed by using various types of processes such as a process using a neural network and a process using a shape within an image.

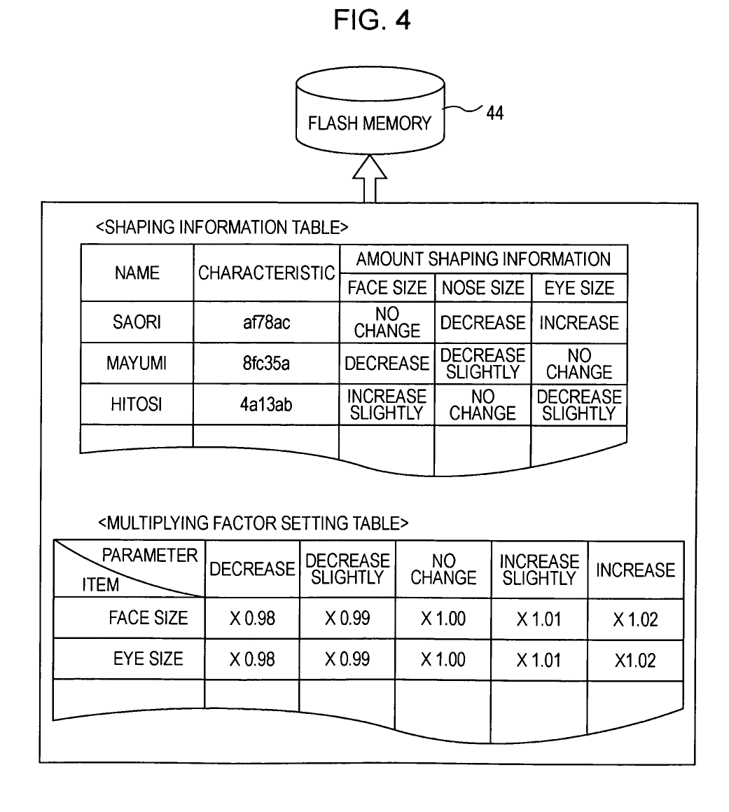

Subsequently, the CPU 41 determines whether one of determined face regions is registered in a shaping information table stored in the flash memory 44 (Step S120). In particular, first, points (for example, 100 spots) are set within the face region, directivity, shading, position relationship, and the like of each point is extracted as a characteristic amount by using Gabor wavelet transformation. Next, a matching process between the characteristic amounts of the read image and characteristic amounts registered in the shaping information table stored in the flash memory 44 is performed. In particular, the square of a difference between values representing each region (for example, an eye region, a nose region, a mouth region, or the like) is accumulated. When the accumulated value is smaller than a predetermined threshold value, high correlation is determined. Here, the shaping information table, as shown in FIG. 4, is a table in which a person's name, a characteristic amount, and shaping information are associated with one another. When this routine is performed for the first time, the face region is not registered in the shaping information table stored in the flash memory 44, and accordingly, a negative result is acquired always in Step S120.

When one of the determined face regions is determined not to have been registered in the shaping information table stored in the flash memory 44 in Step S110, the CPU 41 displays the one of the determined face regions in the display 22 in an enlarged scale and displays a group of icons 51 and a region selecting mark 52 (Step S200, see FIG. 5B). Here, FIGS. 5A, 5B, and 5C are diagrams showing a display example that is displayed for a manual shaping process as an example. The group of icons 51 is configured by region icons (an eye icon 51a, a nose icon 51b, a mouth icon 51c) and a save icon 51d. The region selecting mark 52 encloses a region corresponding to the selected icon among the group of icons 51. For example, when the eye icon 51a is selected, the region selecting mark 52 encloses a position of eyes in the photo image. On the other hand, when the save icon 51d is selected, the region selecting mark 52 encloses the whole face region. Any one of the group of icons 51 can be selected by using the up, down, left, and right buttons 24g. A user selects one icon of the group of icons 51 by pressing the up, down, left, and right buttons 24g, and determines the icon by pressing the OK button 24h in a state that a desired icon has been selected.

Subsequently, the CPU 41 determines whether the icon determined by the user is the region icon or the save icon (Step S210). When the user determines the region icon, the CPU 41 enlarges a region corresponding to the region icon to be displayed in the display 22 and displays a parameter selecting window 53 (Step S220). For example, when the eye icon 51a is selected as the region icon, as shown in FIG. 5C, the eye region is displayed in an enlarged scale and the parameter selecting window 53 is displayed in a lower part of the screen. The parameter selecting window 53 can be changed by pressing the up button or down button of the up, down, left, right buttons 24g. The parameter selecting window 53, for example, is constituted by parameters such as “increase”, “increase slightly”, “no change”, “decrease slightly”, and “decrease”. The user selects the parameter by pressing the up button or down button of the up, down, left, and right buttons 24g, and determines the parameter by pressing the OK button 24h in a state that a desired parameter has been selected.

Subsequently, the CPU 41 waits for user's determination on the parameter (Step S230), shapes the determined region based on the shaping information stored in the flash memory 44 (Step S240), and displays the whole face region with the group of icons 51 and the region selecting mark 52 (Step S200, FIG. 5B). In a multiplying factor determining table stored in the flash memory 44, parameters and multiplying factors used for a shaping process are stored in association with each other (see FIG. 4), and accordingly, the region is shaped based on the parameter selected by the user. For example, when the eye icon 51a is determined in Step S210 and the parameter of “increase slightly” is determined in Step S230, the eye region is enlarged by 1.01 times based on the shaping information (see FIG. 4). Accordingly, the user can change a person's face included in a photo image to a desired face by performing similar operations for each region (the eye region, the nose region, the mouth region, or the like).

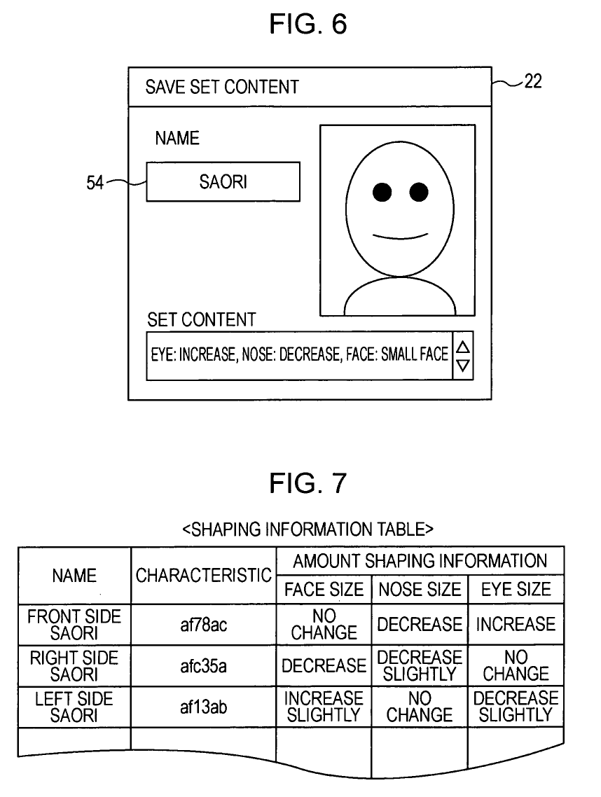

On the other hand, when the user determines the save icon 51d in Step S210, the CPU 41, as shown in FIG. 6, displays a saving content checking screen including a name field 54, to which the user can freely input characters, in the display 22 (Step S250). FIG. 6 is a diagram showing an example of the saving content checking screen. Subsequently, the CPU waits for user's inputting a name to the name field 54 (Step S260), and registers the name input to the name field 54, the characteristic amount of a person displayed in the display 22, and shaping information of regions in the shaping information table stored in the flash memory 44 with associated with one another (Step S270). As a result, when a photo image including the same face region is read next time, a desired face can be automatically formed without user's selecting the shaping information.

In Step S120, when one of the determined face regions is registered in the shaping information table stored in the flash memory 44, the CPU 41 reads shaping information (see FIG. 4) corresponding to the characteristic amount of the determined face region from the shaping information table stored in the flash memory 44 (Step S130), and performs a face shaping process based on the shaping information (Step S140). Here, the face shaping process is a process for shaping regions of a face based on the shaping information. As a result, when shaping information corresponding to the determined face region is registered in advance, a user's desired face can be formed automatically.

After performing the face shaping process in Step S140 or performing the registration process for the shaping information table in Step S270, the CPU 41 determines whether another face region is included in the photo image (Step S150). When another face region is included, the CPU 41 performs Step S120 again. Accordingly, even when a plurality of face regions is included in a photo image, the faces can be formed as faces desired by the user.

On the other hand, when another face region is not included in the photo image, a photo image read out from the memory card M and a photo image after the shaping process are alternately switched (for example, every two seconds) to be displayed (Step S160), and this routine ends. Thus, the user can check a change caused by the shaping process in an easy manner. In addition, the user can print the photo image after the shaping process by using the printing mechanism 30 by pressing the print button 24e. In addition, the user can save the image after the shaping process in the memory card M by pressing the save button 24f as is needed.

Here, correspondence relationships between constituent element of this embodiment and constituent elements according to the present invention will be clarified. The display 22 of this embodiment corresponds to a display unit according to the invention, the memory card slot 15 corresponds to an image reading unit, and the controller 40 corresponds to a characteristic amount extracting unit and a shaping performing unit. In addition, the flash memory 44 corresponds to a shaping information storing unit, and the parameter selecting window 53 corresponds to a shaping information inputting unit. By describing the operation of the photo printer 10 in this embodiment, an example of a method of controlling an image processing device according to an embodiment of the invention is clarified.

According to the photo printer 10 of the above-described embodiment, the characteristic amount of the face region of each person included in a photo image read by the memory card slot 15 is extracted, shaping information associated with the characteristic amount is read out from the flash memory 44, the face of the person is shaped based on the read-out shaping information, and a photo image after the shaping process is displayed in the display 22. In other words, the face of a person displayed in the display 22 is shaped to be displayed based on not shaping information determined uniformly but shaping information associated with the characteristic amount. Accordingly, an appropriate shaping process for each person included in the photo image can be performed automatically.

In addition, since the shaping information can be set by the user in the parameter selecting window 53, a shape of a face close to the user's taste can be formed.

In addition, since a photo image after the shaping process and a photo image before the shaping process are alternately displayed in the display 22, the user can check a change of the photo images before and after the shaping process in an easy manner.

The present invention is not limited to the above-described embodiment, and may be performed in various forms without departing from the technical scope of the invention.

For example, in the above-described embodiment, only one type of the shaping information stored in the shaping information table that is stored in the flash memory 44 is configured for one characteristic amount. However, it may be configured that a plurality of types of the shaping information is registered for one characteristic amount, user's selection of a desired type from among the plurality of types of the shaping information is waited in Step S130, then the type of the shaping information selected by the user is read, and the photo image is shaped in Step S140. In such a case, for example, when there are cases where a gorgeous face is desired to be formed for a specific person and a plain face is desired to be formed for the person, a desired shape of the face can be formed by selecting the type of the shaping information for each case.

In the above-described embodiment, the shaping information table shown in FIG. 4 is used. However, a shaping information table shown in FIG. 7 may be used. In this shaping information table, a person's name, a characteristic amount corresponding to a direction of the person's face, and shaping information are associated with one another. In the registration process for this shaping information table, an input field for a face direction is provided in the saving content checking screen shown in FIG. 6. Then, when the user inputs the face direction to the input filed, the CPU 41 registers the characteristic amount at that moment in the shaping information table as the characteristic amount for the face direction. In such a case, the characteristic amount read out in Step S130 is a characteristic amount corresponding to the person's face direction. Accordingly, even when the user wants different shaping processes for cases where the face is positioned to face the front side and the side, such a demand can be satisfied.

In the above-described embodiment, parameters corresponding to each region of the face which is selected in Step S210 are determined in Step S230, and the regions are shaped in Step S240. However, it may be configured that a pre-set icon used for selecting a pre-set is displayed in Step S200 and a shaping process is performed based on the pre-set in a case where the pre-set icon is selected. In such a case, the user is saved from trouble of selecting parameters of each region of the face. Here, a pre-set, for example, is a stored combination of shaping information of “face size: decrease”, “eye size: increase”, and “mouth size: decrease”. The pre-set may be registered in advance for a combination that is considered to have a high usage frequency or may be registered appropriately by the user.

In addition, in the above described embodiment, it is configured that the size of each region of a face is stored as the shaping information and the size of each region is increased or decreased. However, whitening a color such as a skin color or the like may be performed. Here, as a method of whitening the skin color, for example, a method in which predetermined colors used for representing the human skin in the photo image are converted into brighter colors and the darkest color of image data in the color system is converted into a brighter color may be used.

In the above-described embodiment, the photo image read out from the memory card M and the current photo image are alternately displayed in an automatic manner in Step S160. However, the display may be configured to be switched in a case where the user presses the display switch button 24b.

In the above-described embodiment, the icon is selected by using the up, down, left, and right buttons 24g. However, it may be configured that a transparent touch panel is disposed on the surface of the display 22 and the icon is selected by touching an area corresponding to the group of icons 51 displayed in the display 22 with a pen or a finger. In such a case, since the user can perform a visualized operation, the user's convenience is improved.

In addition, in the above-described embodiment, the shaping information is configured to be stored in the flash memory 44. However, the shaping information may be stored in a removable disk such as a memory stick or a CD-ROM that can be moved. In such a case, even when the user uses a different photo printer, a desired face can be shaped without setting the shaping information again.

What is claimed is:

1. An image processing device comprising:
a display unit;
an image reading unit that reads a photo image;
an extracting unit that extracts a characteristic amount of a face region of a person included in the photo image;
a storing unit that stores the characteristic amount and shaping information that is used for shaping the face region of the person to be associated with each other; and
a performing unit that reads out the shaping information from the storing unit, shapes the face region of the person based on the shaping information, and displays the shaped face region of the person in the display unit.

2. The image processing device according to claim 1,
if there is a plurality of types of the shaping information that is associated with the characteristic amount extracted by the extracting unit, the performing unit displays the plurality of types of the shaping information in the display unit as options, waits for a user to select one of the plurality of the types of the shaping information, shaping the face region of the person based on the selected type of the shaping information, and displays the shaped face region of the person in the display unit.

3. The image processing device according to claim 1, the characteristic amount includes a direction of the face region of the person.

4. The image processing device according to claim 1, further comprising an inputting unit in which the user inputs the shaping information,
wherein the storing unit stores the characteristic amount extracted by the extracting unit and the shaping information input by using the inputting unit in association with each other.

5. The image processing device according to claim 1, wherein the performing unit displays the shaped face region of the person and the face region of the person in the display unit.

6. A method of controlling an image processing device having a display unit, an image reading unit that reads a photo image, and a storing unit that stores a characteristic amount of a face region of a person and shaping information, which is used for shaping the face region of the person, in association with each other, by using computer software, the method comprising:
(a) extracting the characteristic amount of a face region of a person included in the photo image read by the image reading unit; and
(b) reading out the shaping information associated with the characteristic amount extracted in the (a) from the storing unit, shaping the face region of the person based on the shaping information, and displaying the shaped face region of the person in the display unit.

7. A control program for implementing the method according to claim 6 in one or a plurality of computers.
